(19) United States
(12) Patent Application Publication
(10) Pub. No.: US 2025/0309292 A1
(43) Pub. Date: Oct. 2, 2025

(54) MANUFACTURING DEVICE FOR MEMBRANE ELECTRODE ASSEMBLY FOR FUEL CELL

(71) Applicant: HONDA MOTOR CO., LTD., Tokyo (JP)

(72) Inventors: Toshio MIHATA, Tokyo (JP); Satoshi OYAMA, Tokyo (JP); Keiichi IIO, Tokyo (JP); Toru IKEDA, Tokyo (JP)

(21) Appl. No.: 19/063,527

(22) Filed: Feb. 26, 2025

(30) Foreign Application Priority Data
Mar. 29, 2024 (JP) 2024-056301

(51) Int. Cl. H01M 8/04119; H01M 8/1004

(52) U.S. Cl. CPC H01M 8/04149; H01M 8/1004

(57) ABSTRACT

A manufacturing device for a membrane electrode assembly for a fuel cell joins a membrane electrode laminate, having electrodes with gas diffusion layers arranged on both surfaces of an electrolyte membrane, with a frame member integrally joined to a circumferential edge of the electrolyte membrane, to have a membrane electrode assembly. The manufacturing device for a membrane electrode assembly for a fuel cell includes: a mold having a fixed die and a movable die to be moved between a compressing position and a separated position with respect to the fixed die; and a moving mechanism to move the movable die. For the mold, the manufacturing device includes: a heating means to heat the mold; and a humidified gas supply means to supply humidified gas to a surface of the mold.

### CROSS-REFERENCE TO RELATED APPLICATION

This application claims the benefit of priority under 35 U.S.C. § 119 to Japanese Patent Application No. 2024-056301 filed on Mar. 29, 2024, the entire contents of which are incorporated herein by reference.

### TECHNICAL FIELD

The present invention relates to a manufacturing device for a membrane electrode assembly for a fuel cell.

### BACKGROUND OF THE INVENTION

A membrane electrode assembly of a fuel cell generally has a structure of a sub-gasket arranged around a power generation unit. The membrane electrode assembly is generally formed by thermal compression bonding using a heatsink or the like when electrodes of the power generation unit is joined to an electrolyte membrane in a manufacturing step for the membrane electrode assembly (refer to Japanese Patent Application Publication No. 2013-239316, for example).

FIG. 7 is a schematic cross-sectional view of key portions to show a conventional manufacturing device for a membrane electrode assembly for a fuel cell. As shown in FIG. 7, a conventional manufacturing device A100 for a membrane electrode assembly for a fuel cell joins a membrane electrode laminate 100, having electrodes 300 on both surfaces of an electrolyte membrane 200, with a frame member 400 joined to a circumferential edge of the electrolyte membrane 200, to have a membrane electrode assembly 1000. When the membrane electrode laminate 100 is joined with the frame member 400, a mold 500 composed of an upper die 510 and a lower die 520 is used to compress (with a force F100) the membrane electrode laminate 100 and frame member 400 and then the upper die 510 is heated by a heating means.

### SUMMARY

### Problems to be Solved

However, the conventional manufacturing device A100 for a membrane electrode assembly for a fuel cell, shown in FIG. 7, has a problem that when the upper die 510 is heated by a heating means, the frame member 400, which is not to be heated, is also heated with heat H100 by the heating means and thermally deformed.

Additionally, the manufacturing device A100 for a membrane electrode assembly for a fuel cell has a problem that the electrolyte membrane 200 is shrunk, while waiting for compression bonding of the power generation unit, due to desiccation by radiation heat from the heated mold 500, to cause the frame member 400, which has been bonded and coupled with the electrolyte membrane 200, to be deformed.

Then, the present invention is intended to provide a manufacturing device for a membrane electrode assembly for a fuel cell to effectively apply thermal compression bonding to form the membrane electrode assembly for a fuel cell, while preventing a frame member from being thermally deformed.

### Solution to Problems

As a means of solving the problems, the present invention provides a manufacturing device for a membrane electrode assembly for a fuel cell to join a membrane electrode laminate, having electrodes with gas diffusion layers arranged on both surfaces of an electrolyte membrane, with a frame member integrally joined to a circumferential edge of the electrolyte membrane, to have a membrane electrode assembly, the device including: a mold having a fixed die and a movable die to be moved between a compressing position and a separated position with respect to the fixed die; a moving mechanism to move the movable die; a heating means to heat the mold; and a humidified gas supply means to supply humidified gas through the mold to a gap between the movable die and fixed die.

### Advantageous Effects of the Invention

The present invention provides a manufacturing device for a membrane electrode assembly for a fuel cell to effectively apply thermal compression bonding to form a membrane electrode assembly for a fuel cell, while preventing a frame member from being thermally deformed.

### BRIEF DESCRIPTION OF DRAWINGS

FIG. 1 is a schematic cross-sectional view of a manufacturing device for a membrane electrode assembly for a fuel cell according to an embodiment of the present invention;

FIG. 2 is a schematic cross-sectional view of a first modification of the manufacturing device for a membrane electrode assembly for a fuel cell according to the embodiment of the present invention;

FIG. 3 is a schematic cross-sectional view of a second modification of the manufacturing device for a membrane electrode assembly for a fuel cell according to the embodiment of the present invention;

FIG. 4 is a schematic cross-sectional view of a third modification of the manufacturing device for a membrane electrode assembly for a fuel cell according to the embodiment of the present invention;

FIG. 5 is a schematic cross-sectional view of a fourth modification of the manufacturing device for a membrane electrode assembly for a fuel cell according to the embodiment of the present invention;

FIG. 6 is a schematic cross-sectional view of a fifth modification of the manufacturing device for a membrane electrode assembly for a fuel cell according to the embodiment of the present invention; and

FIG. 7 is a schematic cross-sectional view of key portions to show a conventional manufacturing device for a membrane electrode assembly for a fuel cell.

### DETAILED DESCRIPTION

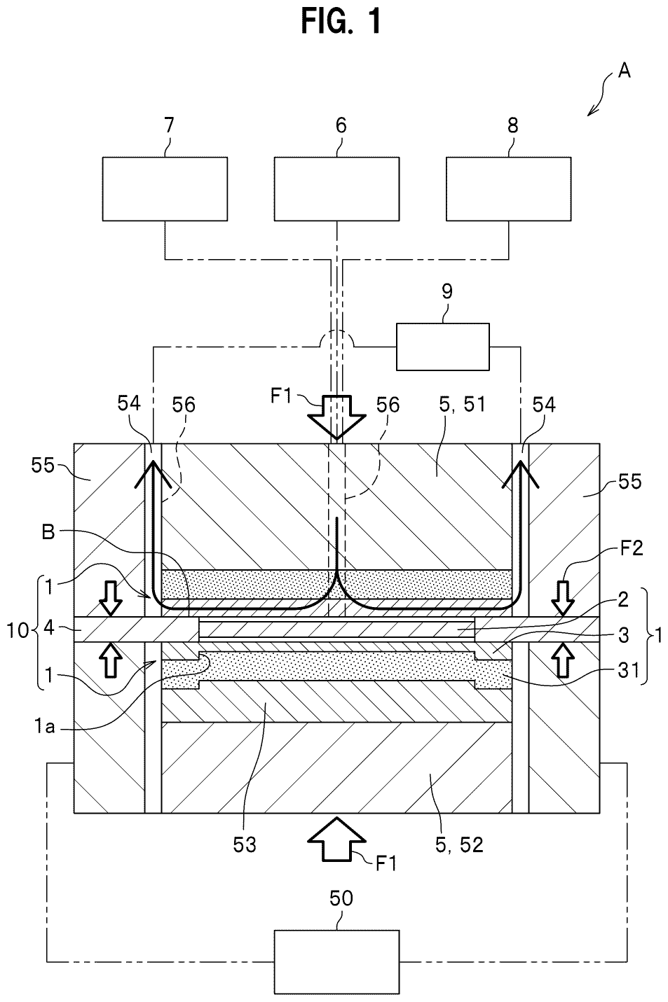

Hereinafter, a description is given of an example of a manufacturing device A (hereinbelow, referred to as a “manufacturing device” when required) for a membrane electrode assembly for a fuel cell according to an embodiment of the present invention, with reference to FIG. 1. Note that the description is given, with a vertically upper side of a mold 5 in FIG. 1 as “UP,” a vertically lower side as “DOWN,” width directions as “LEFT” and “RIGHT.” Before the manufacturing device A is described, a description is given of a membrane electrode assembly 10 compressed by the manufacturing device A for joining.

### <<Membrane Electrode Assembly>>

The membrane electrode assembly 10 is used in a solid polymer fuel cell. The membrane electrode assembly 10 is formed by joining a membrane electrode laminate 1 with a frame member 4.

### <Membrane Electrode Laminate>

The membrane electrode laminate 1 is composed of an electrolyte membrane 2 and a pair of electrodes 3 joined to both of upper and lower surfaces of the electrolyte membrane 2. The membrane electrode laminate 1 has the electrodes 3 arranged on both surfaces of the electrolyte membrane 2. The membrane electrode laminate 1 is formed, at a point thereof joined with a component of the electrode 3, with a stepped portion 1a. A fuel cell using the membrane electrode laminate 1 has one of the pair of the electrodes 3 working as an anode and the other working as a cathode.

### <Electrolyte Membrane>

The electrolyte membrane 2 is formed of perfluoro sulfonic acid polymers such as Nafion (registered trademark).

### <Electrode>

The electrode 3 is formed to have porous gas diffusion layer 31. The gas diffusion layer 31 diffuses reaction gas (hydrogen and oxygen) toward the electrode 3. A porous material having both electrical conductivity and acid tolerance, such as a carbon paper, can be used as the gas diffusion layer 31. The electrode 3 having the gas diffusion layer 31 can exploit gas permeability of the gas diffusion layer 31 to exhaust heated and humidified gas from the mold 5, to allow for compression bonding of the electrode 3 with the electrolyte membrane 2 under a uniformly circulated environment.

### <Frame Member>

The frame member 4 is a sub-gasket integrally connected to a circumferential edge of the electrolyte membrane 2. The frame member 4 is formed of a rim-like member in a substantially rectangular shape formed to surround the electrolyte membrane 2, along a circumferential end of the electrolyte membrane 2. The frame member 4 consists of a sheet-like resin film.

### <<Manufacturing Device>>

The manufacturing device A in FIG. 1 is a device to join the membrane electrode laminate 1 with the frame member 4 integrally joined to the circumferential edge of the electrolyte membrane 2 to have the membrane electrode assembly 10. The manufacturing device A includes the mold 5, a moving mechanism 6 to move a movable die 51 of the mold 5, a heating means 7, a humidified gas supply means 8, a humidified gas exhaust means 9, and a cooling means 50.

### <Mold>

The mold 5 is a member to compress and join the membrane electrode laminate 1 and the frame member 4 together. The mold 5 has a fixed die 52 and the movable die 51 to be moved between a compressing position and a separated position with respect to the fixed die 52.

### <Cushioning Medium>

A cushioning medium 53 is a member to allow for uniformly applying a load F1 from the mold 5, with the moving mechanism 6, to joint surfaces between the electrolyte membrane 2 and electrodes 3. The cushioning medium 53 is provided on the fixed die 52. The cushioning medium 53 consists of a cushion pad in a plate shape having gas permeability and elasticity. Accordingly, the cushioning medium 53 is elastically deformed when compressed, to reduce joining fault due to the stepped portion 1a of the membrane electrode laminate 1.

### <Heat-insulating Layer>

A heat-insulating layer 54 is defined between right and left outer surfaces of the mold 5 and a cooling jig 55. The heat-insulating layer 54 consists of a heat shield material or an air layer. Having the heat-insulating layer 54 between the right and left outer surfaces of the mold 5 and cooling jig 55 allows for stabilizing cooling at an interface between a heated area and the cooling jig 55.

When consisting of a heat shield material, the heat-insulating layer 54 is formed of a plate-like member having thermal insulation properties and provided between the right and left outer surfaces of the mold 5 and cooling jig 55. The heat shield material is formed with a gas exhaust groove to work as a flow path 56 to exhaust gas toward top and bottom surfaces of the mold 5. When consisting of air, the heat-insulating layer 54 is defined as a space to flow air between the right and left outer surfaces of the mold 5 and cooling jig 55. The heat shield material defining the space works as the flow path 56 to exhaust air toward the top and bottom surfaces of the mold 5.

### <Cooling Jig>

The cooling jig 55 is a jig to define the heat-insulating layer 54 around the top and bottom surfaces of the movable die 51 and fixed die 52, and provide the cooling means 50 therethrough. The cooling jig 55 is formed of a rim-like member in a rectangular shape. The cooling jig 55 compresses and fixes the frame member 4 with a compressing force F2 from above and from below. Accordingly, the cooling jig 55 can hold the frame member 4 securely and fixedly. Additionally, the cooling jig 55 minimizes thermal energy applied to the frame member 4 and enhances, through restraint with pressure, reducing the frame member 4 being deformed.

### <Flow Path>

The flow path 56 is a path used to supply and exhaust heating gas from the heating means 7. The flow path 56 may be shared with a path used to supply and exhaust humidified gas from the humidified gas supply means 8. Alternatively, the flow path 56 may have a path for the heating gas separated from a path for the humidified gas. Hereinbelow, as an example of the flow path 56, a description is given of a case where the flow path 56 is used as a path for the heating gas as well as a path for the humidified gas.

As shown in FIG. 1, the flow path 56 is formed from a center portion on the top surface of the movable die 51 toward the electrolyte membrane 2, to have gas flown to the cooling jig 55 along a top surface of the electrolyte membrane 2 and then flown upward between the movable die 51 and cooling jig 55 to the outside.

### <Cooling Means>

The cooling means 50 is a cooling unit to cool (water-cooling or air-cooling) a surface of the mold 5 via the cooling jig 55. The cooling means 50 is configured to include a refrigerant generator (not shown) to generate and supply refrigerant to the cooling jig 55, and a refrigerant flow path (not shown) in a water-jacket shape formed in the cooling jig 55, for example. The cooling means 50 is provided at a point to face the frame member 4. Accordingly, the cooling means 50 allows the cooling jig 55 with cooling function to contact a portion of the frame member 4, which is not heated nor compressed, and compress, while cooling, the frame member 4 so as to be physically restrained.

### <Moving Mechanism>

The moving mechanism 6 is an elevating unit to move up and down the movable die 51 of the mold 5. The moving mechanism 6 consists of an elevating unit to move up and down the movable die 51, using fluid pressure, such as hydraulic pressure, from a fluid pressure supply unit for the upward and downward movement. Note that the moving mechanism 6 can be any unit capable of moving the movable die 51 upward and downward and a mechanism thereof is not specifically limited. For example, the moving mechanism 6 may be an elevating unit to use an electric motor to move the movable die 51 upward and downward.

### <Heating Means>

The heating means 7 is a heating unit to regulate temperature of the mold 5, using heated gas. The heating means 7 is configured to include a heated-gas generator (not shown) to generate and supply heated gas to the flow path 56, and the flow path 56 formed in or around the mold 5. The heating means 7 is preferably provided at the movable die 51, because the fixed die 52 is provided with the cushioning medium 53 to have difficulty in setting up the heating means 7. Accordingly, the flow path 56 is provided in the movable die 51 and between the movable die 51 and cooling jig 55 to supply and exhaust heated gas supplied from the heating means 7. The heating means 7 has the flow path 56 provided only at either (movable die 51) of two dies of the mold 5 for supplying and exhausting heated gas, to regulate temperature of the mold 5 with the bare minimum configuration. Note that the heating means 7 can be anything capable of heating the mold 5, and may be a heater.

### <Humidified Gas Supply Means>

The humidified gas supply means 8 is a humidifying unit to supply humidified gas to a surface of the mold 5. The humidified gas supply means 8 is configured to include a humidified gas generator (not shown) to generate and supply humidified gas (such as water vapor) to the flow path 56, and the flow path 56 formed in or around the mold 5. The humidified gas supply means 8 is provided at a point to face at least the electrolyte membrane 2 of the membrane electrode laminate 1 so as to humidify the electrolyte membrane 2.

### <Humidified Gas Exhaust Means>

The humidified gas exhaust means 9 is an exhaust unit to exhaust humidified gas, supplied by the humidified gas supply means 8 into the flow path 56 within the mold 5, from within the mold 5. The humidified gas exhaust means 9 is configured to include a humidified gas suction unit (not shown) to exhaust the humidified gas from the flow path 56, and the flow path 56 formed in or around the mold 5. The humidified gas exhaust means 9 is provided at a point to face a location B where the membrane electrode laminate 1 is joined with the frame member 4. Note that the humidified gas suction unit (not shown) may not be provided as far as the humidified gas supply means 8 is provided. That is, the humidified gas exhaust means 9 can circulate humidified gas in the flow path 56, with the humidified gas supply means 8 supplying the humidified gas into the flow path 56. Accordingly, the manufacturing device A may be provided with at least the flow path 56 and either one of the humidified gas supply means 8 and humidified gas exhaust means 9.

As described above, the present invention shown in FIG. 1 provides the manufacturing device A for a membrane electrode assembly for a fuel cell to join the membrane electrode laminate 1, having the electrodes 3 with the gas diffusion layers 31 arranged on both surfaces of the electrolyte membrane 2, with the frame member 4 integrally joined to the circumferential edge of the electrolyte membrane 2, to have the membrane electrode assembly 10, and the manufacturing device A includes: the mold 5 having the fixed die 52 and the movable die 51 to be moved between a compressing position and a separated position with respect to the fixed die 52; and the moving mechanism 6 to move the movable die 51, wherein the manufacturing device A further includes, for the mold 5: the heating means 7 to heat the mold 5; and the humidified gas supply means 8 to supply humidified gas through the mold 5 to a gap between the movable die 51 and fixed die 52.

According to such a configuration, the manufacturing device A of the present invention includes; the heating means 7 to heat the mold 5; and the humidified gas supply means 8 to supply humidified gas to a surface of the mold 5. This allows the manufacturing device A to effectively apply thermal compression bonding to manufacture the membrane electrode assembly 10, while preventing the frame member 4 from being thermally deformed.

In addition, the mold 5 with the humidified gas supply means 8 is provided with the humidified gas exhaust means 9 to exhaust humidified gas, supplied to a surface of the mold 5, to the outside of the mold 5. According to such a configuration, the humidified gas supply means 8 has improved flow of humidified gas, with the humidified gas exhaust means 9, to effectively humidify the electrolyte membrane 2.

Further, as shown in FIG. 1, the humidified gas supply means 8 is provided at a point to face the electrolyte membrane 2 of the membrane electrode laminate 1, and the humidified gas exhaust means 9 is provided at a point to face a location where the membrane electrode laminate 1 is joined with the frame member 4. According to such a configuration, the manufacturing device A has the humidified gas supply means 8 arranged to face the electrolyte membrane 2 and has the humidified gas exhaust means 9 arranged to face a location where the membrane electrode laminate 1 is joined with the frame member 4. This allows the electrolyte membrane 2 to have compression bonding applied under an environment with suitable humidity to prevent it from being shrunk.

Still further, as shown in FIG. 1, the heating means 7 and humidified gas supply means 8 use heated and humidified gas to regulate temperature of the mold 5 and humidify the electrolyte membrane 2 of the membrane electrode laminate 1. According to such a configuration, the heating means 7 and humidified gas supply means 8 can accelerate increasing temperature at an interface, using heated and humidified gas, to shorten time of compression bonding and facilitate regulation of setting temperature at the mold 5. Additionally, the heating means 7 and humidified gas supply means 8 can be integrated to reduce space, as compared with a case where heated gas and humidified gas are provided separately from each other.

Still further, as shown in FIG. 1, the cooling means 50 to cool a surface of the mold 5 is provided at a point of the mold 5 to face the frame member 4. According to such a configuration, the manufacturing device A with the cooling means 50 can regulate temperature of the membrane electrode assembly 10 so as to have a suitable temperature, while reducing thermal influence by the heating means 7 to a minimum, to allow for effectively applying thermal compression bonding in a brief time. Accordingly, the cooling means 50 allows for selecting high-tech materials, which have not been selected due to lack of heat resistance, as candidates for the membrane electrode laminate 1 and/or frame member. Additionally, the cooling means 50 provided at the point to face the frame member 4 can apply thermal compression bonding to form the membrane electrode assembly 10, while preventing the frame member 4 from being thermally deformed. The cooling means 50 cooling the mold 5 can also prevent the electrolyte membrane 2 from having drying shrinkage due to radiant heat from the heated mold 5.

Still further, as shown in FIG. 1, the fixed die 52 is provided with the cushioning medium 53. According to such a configuration, the fixed die 52 provided with the cushioning medium 53 can reduce joining fault at components of the electrode 3 due to the stepped portion 1a, even when the membrane electrode laminate 1 is formed with the stepped portion 1a.

Still further, as shown in FIG. 1, the heating means 7 is arranged at the movable die 51. According to such a configuration, the heating means 7 is arranged at the movable die 51, but not at the fixed die 52. Accordingly, the heating means 7 never heats the cushioning medium 53 at the fixed die 52, to allow for effectively heating the mold 5 and effectively arranging the heating means 7 at the mold 5.

### First Modification

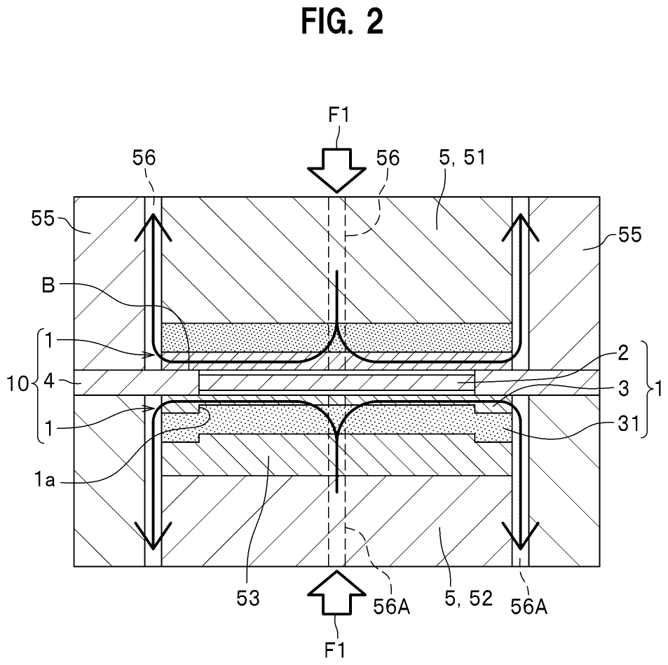

Note that the present invention is not limited to the embodiment and can be variously altered and/or modified within the scope of the technical idea, and it is needless to say that the present invention also includes these alterations and/or modifications. FIG. 2 is a schematic cross-sectional view of a first modification of the manufacturing device for a membrane electrode assembly for a fuel cell according to the embodiment of the present invention. Hereinbelow, the common components in the drawings are indicated by the identical reference signs, and descriptions thereof are skipped.

The embodiment has been described to have the flow path 56 only at the movable die 51 of the mold 5, as an example of the flow path 56, but the present invention is not limited to this configuration. As shown in FIG. 2, a flow path 56A may be formed at the fixed die 52, in addition to the flow path 56 at the movable die 51.

The flow path 56A is formed from a center portion on the bottom surface of the fixed die 52 toward the electrolyte membrane 2, to have gas flown to the cooling jig 55 along a bottom surface of the electrolyte membrane 2 and then flown downward between the fixed die 52 and cooling jig 55 to the outside. The mold 5 formed with the flow paths 56 and 56A as described above can effectively cool the entire manufacturing device A.

In addition, the cushioning medium 53 in FIG. 2 may consist of a cushion pad having gas permeability. According to such a configuration, the cushioning medium 53 consisting of a cushion pad having gas permeability allows heated gas and humidified gas supplied to the mold 5 to permeate, to effectively heat the mold 5. The cushioning medium 53 having gas permeability specification applied thereto allows for additionally supplying gas to the fixed die 52, to supply gas from both of the movable die 51 and fixed die 52.

### Second Modification

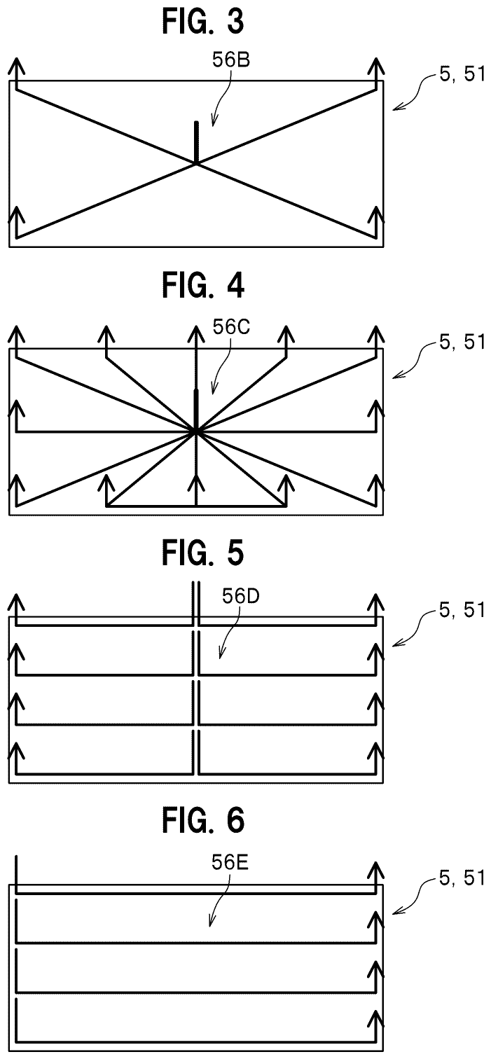

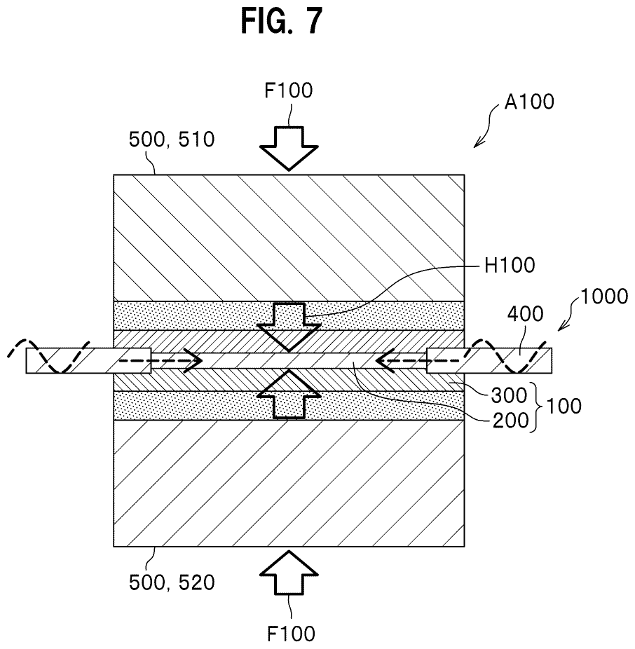

FIG. 3 is a schematic cross-sectional view of a second modification of the manufacturing device for a membrane electrode assembly for a fuel cell according to the embodiment of the present invention. As shown in FIG. 3, the second modification is provided with a flow path 56B to supply gas, in the center, and the four flow paths 56B to exhaust the gas, at four corners of the mold 5. This allows for the above-described flow.

### Third Modification

FIG. 4 is a schematic cross-sectional view of a third modification of the manufacturing device for a membrane electrode assembly for a fuel cell according to the embodiment of the present invention. As shown in FIG. 4, the third modification is provided with flow paths 56C to exhaust gas, not only at four corners of the mold 5 but also at not-at-corner locations, to allow for gas flow as in FIG. 4.

### Fourth Modification

FIG. 5 is a schematic cross-sectional view of a fourth modification of the manufacturing device for a membrane electrode assembly for a fuel cell according to the embodiment of the present invention. As shown in FIG. 5, the fourth modification is provided with flow paths 56D to supply gas, linearly at equal intervals in the center, and provided with four flow paths 56D to exhaust gas, at each of right and left ends of the mold 5, to allow for the above-described flow.

### Fifth Modification

FIG. 6 is a schematic cross-sectional view of a fifth modification of the manufacturing device for a membrane electrode assembly for a fuel cell according to the embodiment of the present invention. As shown in FIG. 5, the fifth modification is provided with four flow paths 56E to supply gas, linearly at equal intervals at one end of the mold 5, and provided with four flow paths 56E to exhaust gas, linearly at equal intervals at the other end of the mold 5, to allow for the above-described flow.

### LIST OF REFERENCE SIGNS

1, membrane electrode laminate; 2, electrolyte membrane; 3, electrode; 4, frame member, 5, mold; 6, moving mechanism; 7, heating means; 8, humidified gas supply means; 9, humidified gas exhaust means; 10, membrane electrode assembly; 31, gas diffusion layer; 50, cooling means; 51, movable die; 52, fixed die; 53, cushioning medium; and A, manufacturing device for membrane electrode assembly for fuel cell (manufacturing device).

What is claimed is:

1. A manufacturing device for a membrane electrode assembly for a fuel cell to join a membrane electrode laminate, having electrodes with gas diffusion layers arranged on both surfaces of an electrolyte membrane, with a frame member integrally joined to a circumferential edge of the electrolyte membrane, to have a membrane electrode assembly, the device comprising:
a mold having a fixed die and a movable die to be moved between a compressing position and a separated position with respect to the fixed die;
a moving mechanism to move the movable die;
a heating means to heat the mold; and
a humidified gas supply means to supply humidified gas through the mold to a gap between the movable die and fixed die.

2. The manufacturing device according to claim 1, wherein
a humidified gas supply means is provided for at least one of the fixed die and movable die, and
a humidified gas exhaust means to exhaust humidified gas, supplied to the gap between the movable die and fixed die, to the outside of the mold is provided for at least one of the fixed die and movable die.

3. The manufacturing device according to claim 2, wherein
the humidified gas supply means is provided at a point to face the electrolyte membrane of the membrane electrode laminate, and
the humidified gas exhaust means is provided at a point to face a location where the membrane electrode laminate is joined with the frame member.

4. The manufacturing device according to claim 1, wherein
the heating means and humidified gas supply means use heated and humidified gas to regulate temperature of the mold and humidify the electrolyte membrane.

5. The manufacturing device according to claim 1, wherein
a cooling means to cool a surface of the mold is provided at a point of the mold to face the frame member.

6. The manufacturing device according to claim 1, wherein
the fixed die is provided with a cushioning medium.

7. The manufacturing device according to claim 6, wherein
the cushioning medium consists of a cushion pad having gas permeability.

8. The manufacturing device according to claim 1, wherein
the heating means is arranged at the movable die.
